(19) United States
(12) Patent Application Publication
(10) Pub. No.: US 2012/0162246 A1
(43) Pub. Date: Jun. 28, 2012

(54) METHOD AND AN APPARATUS FOR AUTOMATIC CAPTURING

(75) Inventors: Barak KINARTI, Rosh-Pina (IL); Vladimir Tkach, Netania (IL); Carmit Pinto, Tsofim (IL); Avishai Geller, Tel Aviv (IL)

(73) Assignee: SAP Portals Israel Ltd., Ra'anana (IL)

(21) Appl. No.: 12/977,084

(22) Filed: Dec. 23, 2010

(51) Int. Cl. G09G 5/00

(52) U.S. Cl. 345/619

(57) ABSTRACT

The subject matter discloses a method for capturing a screen object on a display of a computerized device, the method comprising receiving an indication about the screen object; determining an at least one point of the screen object according to the indication; marking the at least one point with an at least one pattern; wherein the at least one pattern comprises at least two pixels; capturing a display for providing a captured display; wherein the captured display comprises the at least one pattern; searching the at least one pattern in the captured-display; calculating a boundary of the screen object in the captured-display; and extracting the screen object from the captured-display according to the boundary.

### BACKGROUND

The present disclosure relates to the display on a screen in general, and to capturing elements in the display, in particular.

A screen capture is an image file showing a depiction a computerized device screen at a particular point in time. Such a screen capture may be used for saving the depiction of a screen at a given time, for transferring the depiction of the screen to another computerized device, and the like.

In some cases, the user may wish to capture only one screen object from the screen. Such a screen object may be a selected portion of an application data that is displayed on a screen. Such a selected portion of an application data may be, for example, a graph, a table and the like. Such cases may be, for example, when the user wishes to share specific information from the display with other people such as colleagues, customers, partners and the like. In some cases, the screen object that has to be shared between multiple users may be changed dynamically and there is a need to share one or more specific states of the screen object. In some cases, there is a need to periodically share periodical changes on the screen object with other users.

In some other cases, the user may wish to share the screen object with one or more other users who do not have access to the application that displays the screen object. Such cases may be, for example, when users do not have access to the network or do not have permissions to run the application or view the specific data. In such cases, there is a need to capture screen object in order to send the screen object to the other users.

Yet, in some other cases, the user may wish to save periodical changes of a screen object for being analyzed, for example,

There are applications known in the art for capturing a selected portion of a screen. Such an application may be, for example, Screen Garb of Firefox open source manufactured by Mozilla. Screen Garb requires the user to mark the whole area to be captured using a pointing device such as a mouse device. Another application known in the art is Snagit. Snagit is a Microsoft® Windows based desktop application, which enables the user to choose and to capture HTML objects in the web browser. Snagit uses the browser API in order to identify the screen object's boundaries and, as such, is dependent on the specific browser.

In addition, a web browser works in an isolated and protected environment and therefore cannot access operating system APIs and resources, such as the operating system's screen capture mechanism, unless an external program is used, such as a Java Applet, or a JNLP, or any other desktop application.

### BRIEF SUMMARY

One exemplary embodiment of the disclosed subject matter is a method for capturing a screen object on a display of a computerized device, the method comprising receiving an indication about the screen object; determining an at least one point of the screen object according to the indication; marking the at least one point with an at least one pattern; wherein the at least one pattern comprises at least two pixels; capturing a display for providing a captured display; wherein the captured display comprises the at least one pattern; searching the at least one pattern in the captured-display; calculating a boundary of the screen object in the captured-display; and extracting the screen object from the captured-display according to the boundary. The calculating of the boundary is further performed according to the at least one pattern and according to a predefined data. The determining is for at least two points, the marking is for the at least two points and is with at least two patterns; the captured display comprises the at least two patterns and the searching is for the at least two patterns. the at least one pattern is diagonal. A color of the at least two pixels is distinguishable from a surrounding background. The predefined data further comprises one member of the group consisting of a width and a height of the screen object and a radius of a circle. According to some embodiments, the method further comprising repeating the searching if a shape of the boundaries is not a predefined shape. The predefined shape comprises one member of the group consisting of a rectangular, a triangle, a square, an hexagonal, an octagon and a star. The at least one pattern comprises a two by two pixels square. Each of the at least two patterns is unique.

Another exemplary embodiment of the disclosed subject matter is a computerized apparatus for capturing a screen object on a display of a computerized device, the apparatus comprising a receiving unit configured for receiving an indication about the screen object; a marking unit configured for determining at least one point of the screen object according to the indication and for marking the at least one point with an at least one pattern; wherein the at least one pattern comprises at least two pixels; a searching unit configured for searching the at least one pattern in a captured display; a processor configured for calculating boundaries of the screen object in the captured display an extracting unit configured for extracting the screen object from the captured display according to the boundaries; and a capturing unit configured for capturing the display for providing a captured display; wherein the captured display comprises the at least one pattern. The apparatus further comprising the display. Each of the at least two pixels comprises two hundred and sixteen colors. A color of each of the at least two pixels is distinguishable from a surrounding background. The least one pattern comprises a two by two pixels square. The marking unit is further configured for determining at least two points of the screen object. Each of the at least two pixels has a unique pattern. The pattern may be a diagonal.

### THE BRIEF DESCRIPTION OF THE SEVERAL VIEWS OF THE DRAWINGS

The present disclosed subject matter will be understood and appreciated more fully from the following detailed description taken in conjunction with the drawings in which corresponding or like numerals or characters indicate corresponding or like components. Unless indicated otherwise, the drawings provide exemplary embodiments or aspects of the disclosure and do not limit the scope of the disclosure. In the drawings:

FIG. 1 shows a schematic drawing of an apparatus for automatic capturing, in accordance with some exemplary embodiments of the subject matter;

FIG. 2 shows a flowchart diagram of a method automatic capturing, in accordance with some exemplary embodiments of the disclosed subject matter;

FIG. 3 shows a an exemplary display with four patterns, in accordance with some exemplary embodiments of the disclosed subject matter;

FIG. 4a shows an exemplary pattern, in accordance with some exemplary embodiments of the disclosed subject matter; and

FIG. 4b shows an exemplary pattern in zoom mode, in accordance with some exemplary embodiments of the disclosed subject matter.

### DETAILED DESCRIPTION

The disclosed subject matter is described below with reference to flowchart illustrations and/or block diagrams of methods, apparatus (systems) and computer program products according to embodiments of the subject matter, It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

One technical problem dealt with by the disclosed subject matter is to automatically capture a screen object displayed on a screen of a computerized device by pointing at or selecting the screen object and without the need to select part or the whole area to be captured. Pointing may be performed, for example, by clicking on the screen object. The screen object may be, for example, a Graphical User Interface widget.

One other technical problem dealt with by the disclosed subject matter is to automatically capture the screen object regardless of the computerized environment on which the application showing the screen object is executed.

One technical solution comprises receiving an identification of the screen object and automatically capturing the screen object according to the identification, without altering the screen object in a viewable manner. In some exemplary embodiments, the screen object may be selected by pointing on the screen object using a selection device such as a mouse, wherein the identification may be the position of the object within the screen. In some exemplary embodiments, the automatic capturing may comprise automatically marking at least one point of the screen object with at least one pattern; automatically capturing the display after the marking and automatically extracting the screen is object from the captured display according to the at least one pattern. Searching the at least one pattern in the captured display, calculating boundaries of the screen object in the captured display and extracting the screen object from the captured display. The technical solution described herein may be used by a plurality of browsers, a plurality of operating systems, a plurality of platforms and a plurality of devices.

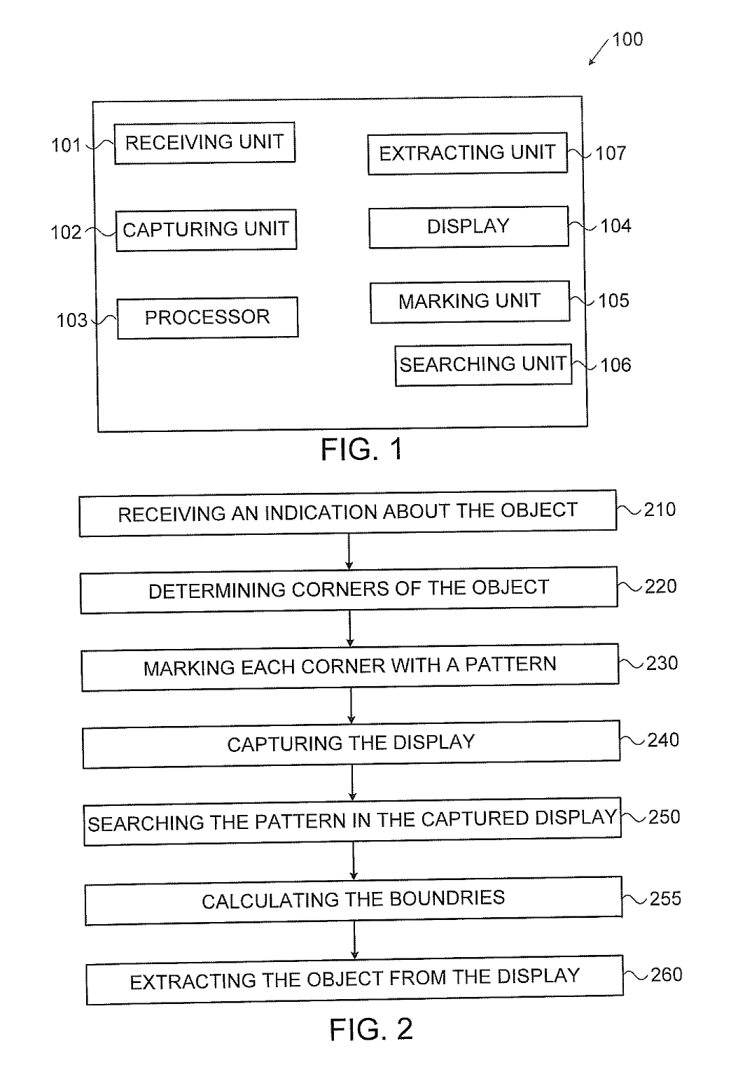

Referring now to FIG. 1 showing a schematic drawing of a computerized machine for automatic capturing, in accordance with some exemplary embodiments of the subject matter. The computerized machine for automatic capturing 100 may comprise a receiving unit 101, a capturing unit 102, a marking unit 105, an extracting unit 107, a searching unit 106 and a processor 103. In some exemplary embodiments, the computerized machine for automatic capturing 100 may comprise a display 104 for displaying the screen object to be captured. In such a case, computerized machine for automatic capturing 100 may act as a client. In some other embodiments, the computerized machine for automatic capturing 100 may not comprise the display 104. In such a case, the machine may act as a server.

The receiving unit 101 may receive an indication of the screen object to be captured. The indication may comprise the position of at least one pixel of the screen object. The indication may be received, for example, as a result of a mouse click of a user, a button click, a menu that refers to the object, a touch using a touch screen or any other input event.

The marking unit 105 may determine at least two points of the screen object according to the indication received by the receiving unit 101. The marking unit 105 may also mark determined points with a pattern. The determining and the marking is further explained in greater detail in association with FIG. 2.

The capturing unit 102 may capture the display after inserting the at least two patterns. The capturing may be implemented by a downloaded Java Web Start application (JNLP) for capturing the user's screen, by Java or by ActiveX, or by Plugin for certain browsers, or by any programming language that can capture a screen. In some exemplary embodiments, the capturing unit may be used via a web browser. In some other exemplary embodiments, the capturing unit may be implemented independently from the browser by the client side or by a desktop application.

A Java Web Start application is a framework developed by Sun Microsystems® that allows users to start application software for the Java Platform directly from the Internet using a web browser. Using a Java Web Start application provides a solution that is independent of the platform and the operating system being used by the application that generates the display.

The searching unit 106 may be used for searching the at least two patterns in the captured display. The searching is further explained in greater detail in association with FIG. 2.

The processor 103 may be used for calculating boundaries of the screen object in the captured display. The calculating is further explained in greater detail in association with FIG. 2.

The extracting unit 107 may be used for extracting the screen object from the captured display according to the boundaries. The extracting is further explained in greater detail in association with FIG. 2.

FIG. 2 shows a flowchart diagram of a method automatic capturing, in accordance with some exemplary embodiments of the disclosed subject matter. At 210, an indication regarding the screen object to be captured may be received. The indication may comprise the position of at least one pixel of the screen object. The indication may be received as a result of a mouse click of a user on the screen object.

At 220, at least two points of the screen object may be determined. The determining of the points may be done by interacting with an application that displays the screen object for receiving information about the boundaries of the screen object. The minimal number of points to be determined is the minimal number of points that is required for calculating the boundaries of the screen object. In some exemplary embodiments, the screen object may be a rectangular and the two points may be points residing on the same diagonal of the screen object. In some other exemplary embodiments, the screen object may be a rectangular and all the four points of the rectangular may be determined. Yet, in some other embodiments only one point is determined and a predefined data related to the captured object, may also be used for the searching for the calculating of the boundaries according to one pattern only and according to the predefined data. The predefined data may be, for example, a width and a height of the screen object, a radius (in cases when the screen object is a circle and the point and a radius may be used for determining the object).

At 230, each of the points that is determined at 220 may be marked with a pattern. The pattern may comprise at least two pixels. The color of each of the pixels may be distinguishable from the surrounding background. Each of the at least two pixels may comprise two hundred and sixteen color. Such colors may be taken from the two hundred and sixteen-color palette, which is supported by all browsers and operating systems. In some exemplary embodiments, the pattern comprises two by two pixels square or two pixels that comprise a diagonal. Such patterns may be found in a captured display even when the web browser is in zoom in mode at the time of the capturing. Yet, in some exemplary embodiments, each point is marked with a unique pattern in order to reduce the odds of identifying wrong pixels as the pattern when searching for the patterns; thus, the pattern's pixel color may be specific to the pattern. The patterns colors values may be, for example Top-Left point—ff0000, 00ff00, 0000ff, ffff00, Top-Right point—0000ff, ffff00, ff00ff, 00ffff , Bottom-Left—ffff00, 00ff00, ff0000, 0000ff and Bottom-Right—00ffff, ff00ff, ff0000, 00ff00. Yet, in some other embodiments, o the top and left coordinates of the first pattern are sent as parameters to the Java application. The coordinates are the x and y coordinates of the first pattern, relative to the browser's view port and not to the user's screen, since the browser always has a frame and may have toolbars. The coordinates are closer to the location of the first pattern in the screen capture image. Using these coordinated in the search described at 250 improves the performance since the search doesn't start scanning from the beginning of the screen capture image, but from a location close to the first pattern.

Yet in some other embodiments only one pattern is determined. Such an embodiment may be, for example when the screen object that is to be captured is shaped as a circle with a known radius, or in general when the pattern indicates a location from which a certain predefined area is captured.

In some exemplary embodiments, the patterns may be defined and implanted in the screen object when creating the screen object. In some other exemplary embodiments, the patterns may be added as a result of capturing the screen object, by for example injecting the pattern objects into the Document Object Module (DOM).

At 240, the display may be captured for providing a captured display. Capturing the display may be done by downloading a Java Web Start application (JNLP) for capturing the user's screen. A Java Web Start application is a framework developed by Sun Microsystems® that allows users to start application software for the Java Platform directly from the Internet using a web browser. Using a Java Web Start application provides a solution that is independent of the platform and of the operating system being used by the application that generates the display. The Java Web Start application may be downloaded from a web browser to the user client after user's approval, and then may run as a standard Java desktop application. Such a desktop application may provide access to the user's resources, and may also capture the user's screen.

AT 250, the patterns are searched in the captured display. Searching the patters may be done by using image processing methods and in particular, by using pattern recognition methods. The searching is for calculating boundaries of the screen object in the captured display.

At 255 calculating of the boundaries of the screen object in the captured display may be done. According to some embodiments, the calculating may be done by calculating boundaries from the at least two patterns; for example if four pattern are found a boundary of a square may be calculated according to the patterns. According to some other embodiments the calculating may be done by using one pattern and the width and the height that were found at 220. In some other exemplary embodiments, the search that is disclosed at 250 may be repeated if the calculated boundaries do not comprise a predefined shape. The repeating of the search is for providing results that are more reliable. The predefined shape may be, for example, a square, a rectangle, an hexagonal, an octagon a star a triangle and the like. For example; if the screen object is a rectangular object, the calculated boundaries may be tested to determine if the calculated boundaries comprises a rectangular shape and if the calculated boundaries do not comprise a rectangular shape, the search for the screen object may be repeated.

At 260, the screen object may be extracted from the captured display according to the boundaries that were calculated at 255. The extraction may be performed by copying or by cropping the relevant content within the determined coordinates. The extracting may result with a cropped image, generated according to the pattern which marked the boundaries of the screen object.

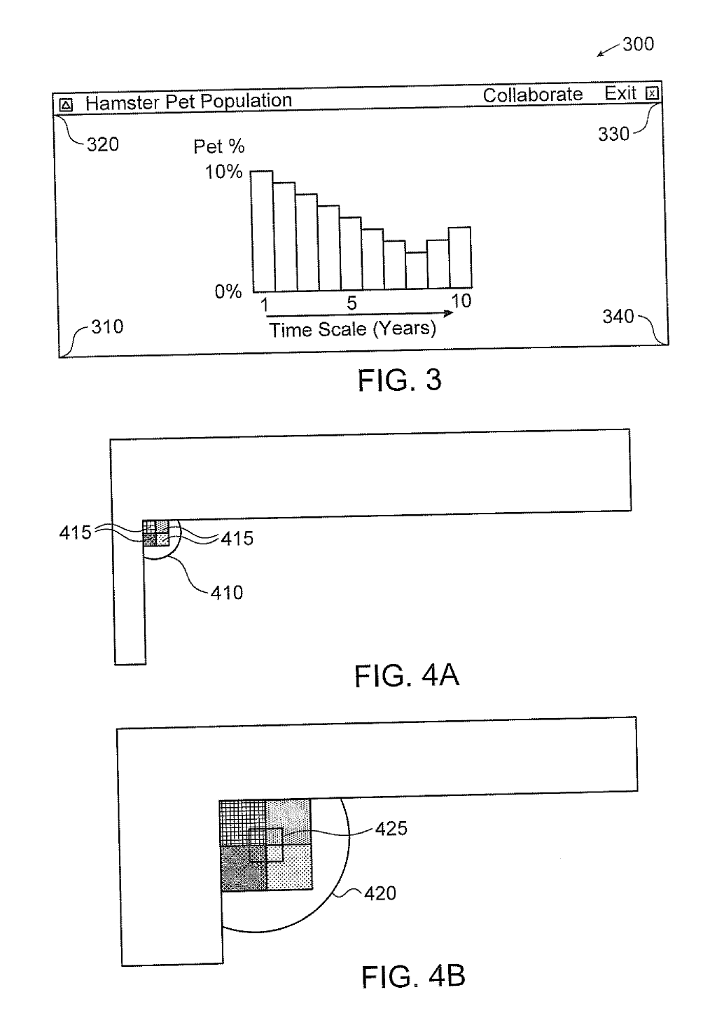

FIG. 3 shows an exemplary screen object with four patterns, in accordance with some exemplary embodiments of the disclosed subject matter. In the exemplary display, a first pattern 320, a second pattern 330, a third pattern 310 and a fourth pattern 340 are located at the four points of a screen object 330.

FIG. 4a shows an exemplary pattern, in accordance with some exemplary embodiments of the disclosed subject matter. In the figure, a pattern 410 is shown with four pixels 415 wherein each pixel has a unique color.

FIG. 4b shows an exemplary pattern in zoom mode, in accordance with some exemplary embodiments of the disclosed subject matter. In the figure, the pattern_420 is show in zoom in mode. In such a case though the pattern is zoomed, the center of the zoomed pattern 425 remains the pattern; thus providing an option to find the pattern even when the capture is take while in the display is in zoom mode.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of program code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As will be appreciated by one skilled in the art, the disclosed subject matter may be embodied as a system, method or computer program product. Accordingly, the disclosed subject matter may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer-usable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, and the like.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

1. A method for capturing a screen object on a display of a computerized device, the method comprising:
receiving an indication about the screen object;
determining an at least one point of the screen object according to the indication;
marking the at least one point with an at least one pattern; wherein the at least one pattern comprises at least two pixels;
capturing a display for providing a captured display; wherein the captured display comprises the at least one pattern;
searching the at least one pattern in the captured-display;
calculating a boundary of the screen object in the captured-display; and
extracting the screen object from the captured-display according to the boundary.

2. The method of claim 1, wherein the calculating of the boundary is further performed according to the at least one pattern and according to a predefined data.

3. The method of claim 1, wherein the determining is for at least two points, the marking is for the at least two points and is with at least two patterns; the captured display comprises the at least two patterns and the searching is for the at least two patterns.

4. The method of claim 1, wherein the at least one pattern is diagonal.

5. The method of claim 1, wherein a color of the at least two pixels is distinguishable from a surrounding background.

6. The method of claim 2, wherein the predefined data further comprises one member of the group consisting of a width and a height of the screen object, and a radius of a circle.

7. The method of claim 1, further comprising repeating the searching if a shape of the boundaries is not a predefined shape.

8. The method of claim 7, wherein the predefined shape comprises one member of the group consisting of a rectangular, a triangle, a square, an hexagonal, an octagon and a star.

9. The method of claim 1, wherein the at least one pattern comprises a two by two pixels square.

10. The method of claim 3, wherein each of the at least two patterns is unique.

11. A computerized apparatus for capturing a screen object on a display of a computerized device, the apparatus comprising:
a receiving unit (101) configured for receiving an indication about the screen object;
a marking unit (105) configured for determining at least one point of the screen object according to the indication and for marking the at least one point with an at least one pattern; wherein the at least one pattern comprises at least two pixels;
a searching unit (106) configured for searching the at least one pattern in a captured display;
a processor (103) configured for calculating boundaries of the screen object in the captured display
an extracting unit (107) configured for extracting the screen object from the captured display according to the boundaries; and
a capturing unit (102) configured for capturing the display for providing a captured display; wherein the captured display comprises the at least one pattern;

12. The apparatus of claim 11, further comprising the display.

13. The apparatus of claim 11, wherein each of the at least two pixels comprises two hundred and sixteen colors.

14. The apparatus of claim 11, wherein a color of each of the at least two pixels is distinguishable from a surrounding background.

15. The apparatus of claim 11, wherein the at least one pattern comprises a two by two pixels square.

16. The apparatus of claim 11, wherein the marking unit is further configured for determining at least two points of the screen object.

17. The apparatus of claim 11, wherein each of the at least two pixels has a unique pattern.

18. The apparatus of claim 11, wherein the pattern is a diagonal.

19. A computer program placed on a magnetic readable medium for capturing a screen object on a display of a computerized device, the computer program comprising:
a first program instruction receiving an indication about the screen object;
a second program instruction for determining an at least one point of the screen object according to the indication;
a third program instruction for marking the at least one point with an at least one pattern; wherein the at least one pattern comprises at least two pixels;
a forth program instruction for capturing a display for providing a captured display; wherein the captured display comprises the at least one pattern;
a fifth program instruction for searching the at least one pattern in the captured-display;
a sixth program instruction for calculating a boundary of the screen object in the captured-display; and
a seventh program instruction for extracting the screen object from the captured-display according to the boundary;
wherein the first, the second, the third, the forth, the fifth, the sixth and the seventh program instructions are stored on the computer readable medium.
